(19) United States
(12) Patent Application Publication
(10) Pub. No.: US 2015/0197674 A1
(43) Pub. Date: Jul. 16, 2015

(54) MOISTURE-CURING SYSTEMS BASED ON CARBODIIMIDES AND ON ANHYDRIDES

(71) Applicants: Emmanouil Spyrou, Schermbeck (DE); Friedrich Georg Schmidt, Haltern am See (DE); Marion Ewald, Marl (DE); Susanne Kreischer, Herten (DE); Andrea Henschke, Duelmen (DE)

(72) Inventors: Emmanouil Spyrou, Schermbeck (DE); Friedrich Georg Schmidt, Haltern am See (DE); Marion Ewald, Marl (DE); Susanne Kreischer, Herten (DE); Andrea Henschke, Duelmen (DE)

(73) Assignee: Evonik Degussa GmbH, Essen (DE)

(21) Appl. No.: 14/430,400

(22) PCT Filed: Sep. 9, 2013
(86) PCT No.: PCT/EP13/68535

§ 371 Date: Mar. 23, 2015

(30) Foreign Application Priority Data
Sep. 27, 2012 (DE) 10 2012 217 552.0

(51) Int. Cl. C09J 175/00; C09D 175/00

(52) U.S. Cl. CPC C09J 175/00; C09D 175/00

(57) ABSTRACT

The invention relates to a composition comprising components which are selected from A) at least one compound containing at least one carbodiimide group, B) at least one compound containing at least one carboxylic anhydride group, C) optionally solvents and D) optionally excipients and additives. The invention also relates to a method for producing, and also using, same.

The invention relates to a composition comprising components selected from A) at least one compound comprising at least one carbodiimide group, B) at least one compound comprising at least one carboxylic-acid-anhydride group, C) optionally solvent, and D) optionally auxiliaries and additives, and also processes for production thereof, and also use thereof.

Moisture-curing polyurethane systems based on isocyanates have been disclosed (e.g. in U.S. Pat. No. 7,317,051, WO2001070839, U.S. Pat. No. 5,369,208 or DE4236562). They are used by way of example as coating materials, adhesives or sealants and they are regarded as user-friendly in applications because they do not require any mixing procedures or stirring procedures. The hardening process is induced by atmospheric moisture, which with isocyanates directly leads first to amine formation and then to urea formation. There are also alternative systems in which the water molecules react firstly with blocked amines (e.g. Schiff bases or oxazolidines) to release the said amines, and the reaction of the said amines with isocyanates then takes place with crosslinking urea formation.

Although isocyanate-containing, moisture-curing polyurethane systems are easy to use, there are nevertheless factors which users find unsatisfactory. Among these is by way of example the relationship between shelf life and reactivity. If no catalysts of any kind are added to the formulations, shelf life is adequate. This means that there is no substantial premature reaction of atmospheric moisture with isocyanates if the correct storage procedure is used. However, there is an attendant increase in the waiting time for the desired hardening on the substrate, e.g. on floors. The increase of drying time is sometimes considerable, depending on exterior temperature and on humidity.

On the other hand, if catalysts are admixed with the formulation, hardening occurs within an acceptable time, but at the same time shelf life decreases considerably, and undesired clouding and precipitation therefore occurs during storage.

For the abovementioned reasons, there continues to be a requirement for novel moisture-curing coating materials, adhesives, and sealants which do not have the abovementioned disadvantages or exhibit an improved relationship between shelf life and reactivity in applications. A particular object consisted in finding novel reactive compositions which have good shelf life and nevertheless have adequate reactivity during use. The preferred intention is that after one week of storage (with exclusion of water) the compositions exhibit at most 5% reaction of the reactive groups, but that in the presence of water at least 50% of the reactive groups have reacted within 3 days.

The objects are achieved by using the composition according to claim 1, and also by using the process according to claim 13.

The said requirements are met by the claimed composition comprising components comprising carbodiimide groups and components comprising anhydride groups, in particular anhydride groups derived from acids, particularly preferably carboxylic-acid-anhydride groups.

The invention therefore provides a composition comprising carbodiimides, in particular an activatable or reactive composition, preferably a composition that is reactive in the presence of moisture and/or water, where the composition comprises components selected from

A) at least one compound comprising at least one carbodiimide group and
B) at least one compound comprising at least one anhydride group.

According to one preferred alternative, the composition comprises

A) at least one compound comprising at least one carbodiimide group and
B) at least one compound comprising at least one anhydride group,
C) a solvent and
D) optionally auxiliaries and additives.

A feature of the claimed composition is that it is reactive or activatable. This means that the composition is reactive in the presence of water or moisture or that the composition is activatable by moisture, particularly preferably that the composition can be polymerized to give a polyurethane and/or polyurea or to give a composition comprising urethane groups and/or comprising urea groups.

When preferred compositions are stored (with exclusion of water), the extent of reaction of the reactive groups, which is determined by way of the content of carbodiimide groups, is at most 5% after one week. At the same time, in the presence of water at least 50% of carbodiimide groups have been consumed by reaction within 3 days. Shelf life can be determined by means of GC analysis or optionally by means of Raman or ¹³C NMR spectroscopy.

The invention provides a composition comprising at least one compound A) which comprises at least two carbodiimide groups. It is particularly preferable that the compounds A) have an average of at least two carbodiimide groups. The invention also provides compositions in which from 10 to 100 mol % of the compounds A) have two carbodiimide groups; in particular, from 30 to 100 mol %, preferably from 45 to 100 mol %, of the compounds A have two carbodiimide groups.

The invention further provides a composition comprising: A) at least one compound comprising at least one carbodiimide group and B) at least one compound comprising at least one anhydride group, where the composition has a molar ratio of carbodiimide groups in the compound A) to anhydride group of the compound B) of from 10:1 to 1:10, preferably from 10:1 to 1:5, in particular from 5:1 to 1:5, with preference from 3:1 to 1:3, with particular preference 2:1, in each case with a tolerance range of plus/minus 0.5, preferably with a tolerance range of plus/minus 0.2. According to one particularly preferred alternative, the invention also provides a composition comprising: A) at least one compound comprising at least one carbodiimide group and B) at least one compound comprising at least one carboxylic-acid-anhydride group, where the composition has a molar ratio of carbodiimide groups in the compound A) to carboxylic acid groups that can be liberated in the compound B) of from 10:1 to 1:10, preferably from 10:1 to 1:5, in particular from 5:1 to 1:5, with preference from 3:1 to 1:3, with particular preference from 2:1 to 1:1, in each case with a tolerance range of plus/minus 0.5, preferably with a tolerance range of plus/minus 0.2. Particular preference is given here to an approximately equimolar ratio, i.e. a ratio of about 1:1, of the carbodiimide group with respect to the carboxylic acid group liberated.

The invention further provides a composition of which the content of compounds comprising carbodiimide groups and comprising anhydride groups in the entire composition is from 10 to 100% by weight, preferably from 40 to 99.99% by weight, based on the entire composition.

The carbodiimides A) used according to the invention can be obtained from isocyanates, preferably from diisocyanates. Diisocyanates can comprise any desired aliphatic, cycloaliphatic and/or (cyclo)aliphatic, or aromatic diisocyanates.

Suitable aliphatic diisocyanates advantageously have from 3 to 16 carbon atoms, preferably from 4 to 12 carbon atoms, in the linear or branched alkylene moiety, and suitable cycloaliphatic or (cyclo)aliphatic diisocyanates advantageously have from 4 to 18 carbon atoms in the cycloalkylene moiety, preferably from 6 to 15 carbon atoms. The expression “(cyclo)aliphatic diisocyanates” is understood by the person skilled in the art to mean simultaneous presence of NCO groups bonded to a ring and NCO groups bonded to an aliphatic system, as is by way of example the case in isophorone diisocyanate. In contrast, the expression “cycloaliphatic diisocyanates” means those which have only NCO groups directly bonded at the cycloaliphatic ring, for example H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, decane diisocyanate, undecane diisocyanate, and/or dodecane diisocyanate.

The following are equally suitable: methyldiphenyl diisocyanate (MDI), for example diphenylmethane 2,2′-diisocyanate, diphenylmethane 2,4-diisocyanate, diphenylmethane 4,4′-diisocyanate and mixtures comprising the abovementioned MDIs, tolylene 2,4- and/or 2,6-diisocyanate (TDI), 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, methylenebis(cyclohexyl) 2,4′-diisocyanate, 1,4-diisocyanato-4-methylpentane.

The aliphatic, (cyclo)aliphatic and/or cycloaliphatic diisocyanates are particularly suitable for the production of the compounds (A) comprising carbodiimide groups. Particular preference is given to isophorone diisocyanate (IPDI), hexamethylene diisocyanate (HDI), diisocyanatodicyclohexylmethane (H₁₂MD1), 2-methylpentane diisocyanate (MPDI), 2,2,4-trimethylhexamethylene diisocyanate/2,4,4-trimethylhexamethylene diisocyanate (TMDI), and norbornane diisocyanate (NBDI). It is particularly preferable to use IPDI, HDI and H₁₂MDI. Mixtures comprising diisocyanates or mixtures of the diisocyanates can be used with equal preference.

The invention likewise provides a composition comprising compounds which have carbodiimide groups and which have been produced by a reaction of an isocyanate, in particular of a diisocyanate, preference being given to aliphatic, (cyclo)aliphatic and/or cycloaliphatic diisocyanates, in particular in the presence of a catalyst. Suitable catalysts and reaction conditions are known per se to the person skilled in the art, and suitable catalysts are mentioned below.

The compounds comprising carbodiimide groups can be produced in the presence of high-activity catalysts. A detailed description of suitable catalysts and production methods is found by way of example in Houben-Weyl, Methoden der organischen Chemie [Methods of organic chemistry], Volume E4, Kohlensaurederivate [carbonic acid derivatives], Georg-Thieme-Verlag, Stuttgart, 1983, pp. 897 to 900 and 910, and also in Chemical Reviews, Volume 67, Number 2, 1967, pp. 107-113, or in Angew. Chem., 1962, No. 21, 801-806. Catalysts for producing carbodiimides are also described in U.S. Pat. No. 2,941,966, U.S. Pat. No. 2,853,518, U.S. Pat. No. 2,853,473 or DE 35 12 918. Preferred catalysts are phospholenes and phospholanes, and also their oxides and sulphides, particularly preferably of phospholene oxide type. Examples of catalysts frequently used are 1-methyl-2-phospholene 1-oxide, 1-methyl-3-phospholene 1-oxide, 3-methyl-1-phenyl-3-phospholene 1-oxide and 3-methyl-1-phenyl-2-phospholene 1-oxide, and also the corresponding phospholanes. It is preferable to use 3-methyl-1-phenyl-2-phospholene-1-oxide. Phosphine oxides are equally suitable.

It is particularly preferable that compound A) is one selected from compounds comprising carbodiimide groups and NCO groups and/or from prepolymers comprising carbodiimide groups, where in particular the prepolymers comprise urethane groups or urea groups. Preferred prepolymers comprising carbodiimide groups comprise urethane groups.

The form in which the compounds comprising carbodiimide groups can be used as component A is pure form, i.e. comprising NCO groups, or else preferably prepolymer form, i.e. not comprising NCO groups. To form prepolymer compounds, compounds comprising carbodiimide groups and isocyanate groups are reacted with monomeric, oligomeric or polymeric polyols or polyamines. Monomeric polyols and oligomeric polyols comprise polyhydric alcohols such as the monomeric diols and triols, and compounds having at least two HO groups (hydroxyl groups) and corresponding oligomers. Polyamines comprise compounds having at least two primary and/or secondary amine groups, for example NH groups and/or NH₂ groups. Additional use of monoalcohols or monoamines is possible for chain termination.

Examples of monomeric diols that can be used are the following, but the polyols are not restricted thereto: ethylene glycol, triethylene glycol, 1,4-butanediol, 1,5-pentanediol, 1,6-hexanediol, 3-methyl-1,5-pentanediol, neopentyl glycol, 2,2,4-(2,4,4)-trimethylhexanediol, and neopentyl glycol hydroxypivalate.

Other monomeric tri- and polyols that can be used can by way of example be the following, but the polyols are not restricted thereto: trimethylolpropane, ditrimethylolpropane, trimethylolethane, 1,2,6-hexanetriol, 1,2,4-butanetriol, tris(8-hydroxyethyl) isocyanurate, pentaerythritol, mannitol and sorbitol.

Preferred polymeric polyols or polyamines can be those selected from the following, but other polyols familiar to the person skilled in the art can equally be used, examples being polyesters, polycaprolactones, polyethers, polycarbonates, polyamides, polyurethanes, polyureas and poly(meth)acrylates having terminal OH and/or terminal amine groups.

The reaction of the compounds comprising carbodiimide groups and NCO groups with the polyols and/or polyamines to form the prepolymers of component A comprising carbodiimide groups takes place in suitable assemblies, for example stirred tanks, flow tubes or extruders, in each case with or without solvent at temperatures from room temperature (from 20 to 25° C.) to 200° C., preferably at from 40 to 80° C. The molar ratio here of the NCO groups to the NCO-reactive groups, e.g. OH groups or NH groups, is from 5:1 to 1:5, in particular from 3:1 to 1:3, preferably from 2:1 to 1:3, and it is particularly preferable that the molar ratio is approximately stoichiometric, i.e. around 1:1, i.e. almost stoichiometric. A deviation of plus/minus 0.5 is acceptable here, in particular plus/minus 0.2, preferably plus/minus 0.1.

The invention further provides compositions which comprise compound(s) A) with a molar mass Mn of from 300 to 5000 g/mol (Mn, number-average molar mass), and in particular the average molar mass Mn of the compounds A) is from 300 to 5000 g/mol. It is equally preferable to use, as compound A), carbodiimides which bear an average of at least two carbodiimide groups per molecule. In addition or alternatively, the said compounds A) have an average molar mass Mn of from 300 to 5000 g/mol.

Component B) comprises a compound comprising at least one anhydride group derived from an acid, preferably a carboxylic-acid-anhydride group, and it is particularly preferable here that at least one compound B) has an intramolecular carboxylic-acid-anhydride group, and it is preferable here that all of the compounds of component B) have at least one intramolecular carboxylic-acid-anhydride group. Suitable components of the compound B) therefore preferably take the form, prior to addition to the composition, of solid pure substance, where the carboxylic-acid-anhydride groups are preferably unhydrolyzed. The amount of carboxylic-acid-anhydride groups in intact form is preferably up to 100 mol %, more preferably from 80 to 99.999 mol %.

The abovementioned components of the compound B) are preferably those selected from the following compounds, but the compounds are not restricted to those mentioned: succinic anhydride, malonic anhydride, maleic anhydride, 1,2-cyclohexanedicarboxylic anhydride, phthalic anhydride and pyromellitic dianhydride, mellitic anhydride, trimellitic anhydride, and organofunctionally substitituted derivatives of these and mixtures comprising at least two of the compounds mentioned. It is equally possible to use, as substituted derivatives of the compounds B), alkyl-substituted derivatives of the compound having at least one carboxylic-acid-anhydride group, preferably having from 1 to 20 C atoms, or other compounds which comprise carboxy groups and have at least one carboxylic-acid-anhydride group, preferably dodecenylsuccinic anhydride, methylhexahydrophthalic anhydride, or 4-methacryloxyethyl derivative of trimellitic anhydride (4-META).

Compounds that can be used as component B are any of those which have at least one carboxylic-acid-anhydride group: in simple cases, simple intramolecular carboxylic anhydrides having from 2 to 8 carbon atoms. Preferred compounds have a carboxylic-acid-anhydride group formed intramolecularly. These are in particular succinic anhydride, malonic anhydride, maleic anhydride, 1,2-cyclohexanedioic anhydride, phthalic anhydride, pyromellitic dianhydride and trimellitic anhydride. Carboxylic anhydrides formed intermolecularly can equally be used.

The solvents optionally present in the composition are preferably anhydrous and are in particular inert with respect to the carbodiimide groups, anhydride groups and/or NCO groups. Preferred solvents C) are solvents that are inert in the presence of the compounds A) and B), and in particular the solvents are also inert under the reaction conditions, for example during the subsequent polymerization or polyaddition process. It is preferable to use, as solvent C), an organic or inorganic inert liquid or a mixture comprising at least two inert liquids. It is particularly preferable that the solvent is anhydrous, i.e. that the solvent comprises at most 10 ppm by weight of water, in particular at most 5 ppm by weight, preferably at most 1 ppm by weight. The water content can be determined by methods known to the person skilled in the art, for example by the Karl Fischer method.

Some preferred solvents are mentioned below, and in each case can be used individually or in the form of a mixture of at least two solvents. Solvent C) is preferably one selected from aromatic or aprotic solvents, preferably from acetone, ethyl acetate, butyl acetate, xylene, or from aromatic solvents with boiling points above xylenes, in particular from aromatic solvents with boiling points of from 145 to 250° C., methoxypropyl acetate, dibasic esters and mixtures comprising at least two of the compounds mentioned. Solvents C) that can be used are generally any of the inert organic and inorganic liquids or, respectively, solvents that are liquid under the reaction conditions and inert under the reaction conditions. In particular, these can be the following products: Solvesso 100, Solvesso 150, methoxypropyl acetate and dibasic esters (DBE, DuPont, boiling point 103° C., CH₃CO₂(CH₂)ₙCO₂CH₃, n=from 2 to 25:25%, n=from 3 to 55: up to 65%, n=from 4 to 10: up to 25%). A material can that can be used here, which is an aromatic solvent, is Solvesso 100, from 95 to 100% of low-boiling-point aromatic compounds or aromatic solvent naphtha (*64742-95-6), from 0 to 5% of mixed xylenes (1330-20-7)[215-535-7], from 35 to 45% of 1,2,4-trimethylbenzene (95-63-6), and from 0 to 5% of cumene (98-82-8). Solvesso 100 has 99% by weight aromatics content (boiling point from 164 to 180° C.); Solvesso 150 (aromatic solvent, aromatics content 99% by weight, boiling point from 181 to 207° C.).

The composition can moreover also comprise auxiliaries and additives D) in addition to components A) and B), and also optionally C). The auxiliaries and additives can be those selected from:
(i) from 0.05 to 5% by weight of levelling agents and/or light stabilizers, where by way of example polysilicones or acrylates are used as levelling agents and/or by way of example sterically hindered amines can be used as light stabilizers and/or conventional auxiliaries can be used,
(ii) from 0 to 50% by weight of fillers and/or pigments, in particular titanium dioxide
(iii) from 0.001 to 1% by weight of catalyst, in particular dibutyltin dilaurate, or tertiary amines, e.g. 1,4-diazabicyclo[2.2.2]octane, and also making up 100% by weight of the entire composition, component A) at least one compound comprising at least one carbodiimide group and component B) at least one compound comprising at least one anhydride group, in particular one intramolecular carboxylic-acid-anhydride group, and optionally C) solvent.

The composition can preferably comprise:
(i) from 0.1 to 2.5% by weight of levelling agents, light stabilizers, where by way of example polysilicones or acrylates are used as levelling agents and/or by way of example sterically hindered amines are used as light stabilizers and/or the auxiliaries used comprise those mentioned in EP 669 353,
(ii) from 5 to 25% by weight of fillers and/or pigments,
(iii) from 0.01 to 0.5% by weight of catalyst, in particular organometallic compounds, dibutyltin dilaurate, or tertiary amines, e.g. 1,4-diazabicylco[2.2.2]octane, and also making up 100% by weight of the entire composition, component A) at least one compound comprising at least one carbodiimide group and component B) at least one compound comprising at least one anhydride group, and optionally C) solvent.

Compounds A) and B) are used in formulations of the composition, optionally in the presence of a solvent or solvent mixture C) and optionally in the presence of auxiliaries and additives D), the molar ratio of the reactive groups, carbodiimide to anhydride, being from 10:1 to 1:5, in particular from 5:1 to 1:3, but preferably about 2:1, i.e. stoichiometric. In the absence of moisture or water, the carbodiimide group and the carboxylic-acid-anhydride group do not react with one another. In the presence of H₂O or on ingress of H₂O, the carboxylic-acid-anhydride group is hydrolysed to give two carboxylic acid groups. Atmospheric moisture can be sufficient for the hydrolysis process. The carboxylic acids then react rapidly with the carbodiimide group, with crosslinking.

The invention also provides a process for the production of a composition, in particular of a composition that is activatable by moisture or that is reactive in the presence of moisture, and also a composition obtainable by the said process, where the following components

A) at least one compound comprising at least one carbodiimide group,
B) at least one compound comprising at least one anhydride group,
C) optionally solvent,
D) optionally auxiliaries and additives are mixed with one another.

It is particularly preferable here, in the process for the production of the abovementioned composition, the composition is produced in essence in anhydrous form and is drawn off in particular with exclusion of moisture into a hermetically sealable container, and that the container is preferably in essence sealed in such a way that the composition does not come into contact with moisture.

Component A) in the process according to the invention is preferably selected from compounds comprising carbodiimide groups and NCO groups and/or from prepolymers comprising carbodiimide groups, where the prepolymers are produced by reacting compounds comprising carbodiimide groups and isocyanate groups with monomeric, oligomeric or polymeric polyols and/or polyamines, and optionally here adding monoalcohols and/or monoamines at any juncture during the reaction. Polyols comprise in particular the abovementioned polyhydric monomeric or oligomeric alcohols, and also polymeric polyols. The following can also by way of example be used as polyols or polyamines: polyesters, polycaprolactones, polyethers, polycarbonates, polyamides, polyurethanes, polyureas and poly(meth)acrylates having terminal OH groups and/or terminal amine groups. Polymeric amines that can be used are by way of example the following: polyetheramines, polyether glycol amine or polypropylene glycol amine.

The invention also provides a process for the production of the composition, where the prepolymers, in particular the prepolymers comprising carbodiimide groups, are produced by adjusting the molar ratio of the NCO groups of the isocyanates to NCO-reactive groups, such as hydroxy groups or NH groups of the polyols or polyamines, to from 5:1 to 1:5, preferably adjusting to a ratio of 1:1, and optionally reacting at a temperature of from 10 to 200° C. Reaction at from 40 to 120° C. is preferred.

The invention also provides the use of a composition where a defined amount of moisture, water or solvents comprising water is admixed with the composition, in particular for the activation of the composition or for the reaction, preferably for the crosslinking of an activated composition. The activation of the composition takes place through the reaction of H₂O with a carboxylic anhydride with formation of two carboxylic acid groups, which then react with one or two carbodiimide groups. The invention therefore provides a moisture-activatable composition comprising compounds comprising carbodiimide groups and compounds comprising carboxylic-acid-anhydride groups, which optionally comprises solvent, and which optionally comprises auxiliaries and additives.

The invention further provides the use of a composition, where a defined amount of at least one organic compound comprising at least one NH group and/or comprising at least one HO group is admixed with the composition, and also optionally a defined amount of moisture, water or solvents comprising water is admixed with the composition. The composition can moreover be used for the production of coating material, of adhesive, of sealants, of insulation materials and/or of mouldings.

The invention also provides a formulation comprising a composition comprising A) at least one compound comprising at least one carbodiimide group and B) at least one compound comprising at least one anhydride group in a molar ratio of about 2:1, and also auxiliaries and additives.

The invention is explained below with reference to some examples, but is not restricted thereto. However, the features in the examples can serve for general explanation of the invention and are therefore generalizable.

### Experimental Section:

The reactivity and shelf life of formulations made of carbodiimides and anhydrides is demonstrated below in examples.

a) 11.8 g of dicyclohexylcarbodiimide (DCC, Aldrich) were dissolved with 4.5 g of hexahydro-phthalic anhydride (Aldrich), in a molar ratio of 2:1, in 50 ml of DMF and 2 g of hexadecane were admixed as standard.

In further experiments, the following were added to a): 0.5 g of water (b) and additionally also 0.1 g of 1,4-diazabicyclooctane, DABCO (c) as catalyst. The three specimens were then allowed to stand at room temperature, and GC was used to study the residual content of DCC as a function of time.

TABLE 1
GC (area percent)

| Time | 0 h | 50 h | 100 h | 168 h |
|---|---|---|---|---|
| a) | 100% | 100% | 100% | 100% |
| b) +H₂O | 100% | 51% | 39% | 28% |
| c) +H₂O + DABCO | 100% | 33% | 16% | 9% |

From the results of the studies it can be concluded that a composition or formulation made of carbodiimides and anhydrides is stable under storage conditions, in particular with exclusion of moisture, but reacts spontaneously on exposure to water. The said reaction can be accelerated markedly by addition of suitable catalysts.

1. Composition comprising carbodiimides, characterized in that the composition comprises components selected from
A) at least one compound comprising at least one carbodiimide group,
B) at least one compound comprising at least one anhydride group,
C) optionally solvent,
D) optionally auxiliaries and additives.

2. Composition according to claim 1,
characterized in that
the composition is activatable or reactive, in particular in the presence of water or moisture.

3. Composition according to claim 1,
characterized in that
the compound having at least one carbodiimide group has been produced through reaction of an isocyanate, in particular of a diisocyanate, in the presence of a catalyst.

4. Composition according to claim 1,
characterized in that
the compound A) in one selected from compounds comprising carbodiimide groups and NCO groups and/or from prepolymers comprising carbodiimide groups, where the prepolymers comprise urethane groups and/or urea groups.

5. Composition according to claim 1,
characterized in that
at least one compound A) comprises at least two carbodiimide groups, and in particular the compounds A) comprise an average of at least two carbodiimide groups.

6. Composition according to claim 1,
characterized in that
the molar mass Mn of the compounds A) is from 300 to 5000 g/mol, and in particular the average molar mass Mn of the compounds A) is from 300 to 5000 g/mol.

7. Composition according to claim 1,
characterized in that
the compound B) has at least one carboxylic-acid-anhydride group, and in particular at least one compound B) has an intramolecular carboxylic-acid-anhydride group.

8. Composition according to claim 1,
characterized in that
the compound B) is one selected from succinic anhydride, malonic anhydride, maleic anhydride, 1,2-cyclohexanedicarboxylic anhydride, phthalic anhydride and pyromellitic dianhydride, mellitic anhydride, trimellitic anhydride, and organofunctionally substitituted derivatives of these and mixtures comprising at least two of the compounds mentioned.

9. Composition according to claim 1,
characterized in that
the solvent C) is a solvent that is inert in the presence of the compounds A and B, preferably an organic or inorganic inert liquid or a mixture comprising at least two inert liquids.

10. Composition according to claim 9,
characterized in that
the solvent C) is one selected from aromatic or aprotic solvents, preferably from acetone, ethyl acetate, butyl acetate, xylene, mixtures of aromatic solvents with boiling points above 145° C., methoxypropyl acetate, dibasic esters and mixtures comprising at least two of the compounds mentioned.

11. Composition according to claim 1,
characterized in that
it comprises auxiliaries and additives D) selected from
(i) from 0.05 to 5% by weight of levelling agents and/or light stabilizers,
(ii) from 0 to 50% by weight of fillers and/or pigments,
(iii) from 0.001 to 1% by weight of catalyst, and also,
making up 100% by weight of the entire composition, A) at least one compound comprising at least one carbodiimide group, and B) at least one compound comprising at least one anhydride group, and optionally C) solvent.

12. Composition according to claim 1,
characterized in that it comprises
A) at least one compound comprising at least one carbodiimide group and B) the at least one compound comprising at least one anhydride group in a molar ratio of carbodiimide groups in the compound
A) to carboxylic acid groups that can be liberated in the compound B) of from 10:1 to 1:10, preferably from 10:1 to 1:5, in particular from 5:1 to 1:5, with preference from 3:1 to 1:3, with particular preference from 2:1 to 1:1, in each case with a tolerance range of plus/minus 0.5.

13. Process for the production of a composition according to claim 1,
characterized in that the components
A) at least one compound comprising at least one carbodiimide group,
B) at least one compound comprising at least one anhydride group,
C) optionally solvent and
D) optionally auxiliaries and additives are mixed with one another.

14. Process for the production of a composition according to claim 13,
characterized in that
the composition is produced in essence without water and in particular with exclusion of moisture is drawn off into a hermetically sealable container and in particular the container is in essence sealed in such a way that the composition does not come into contact with moisture.

15. Process according to claim 13,
characterized in that
component A) is one selected from compounds comprising carbodiimide groups and NCO groups and/or from prepolymers comprising carbodiimide groups, where the prepolymers are produced by reacting compounds comprising carbodiimide groups and comprising isocyanate groups with monomeric, oligomeric or polymeric polyols and/or polyamines, and optionally here adding monoalcohols and/or monoamines at any juncture during the reaction.

16. Process according to claim 15,
characterized in that
the prepolymers are produced by adjusting the molar ratio of the NCO groups of the isocyanates to NCO-reactive groups, such as hydroxy groups of the polyols or NH groups of the amines, to from 5:1 to 1:5, preferably adjusting to a ratio of 1:1, and optionally reacting at a temperature of from 10 to 200° C., where isocyanates or diisocyanates are used for the production of the prepolymers, and the diisocyanates here comprise aliphatic, cycloaliphatic and/or (cyclo)aliphatic, or aromatic diisocyanates having from 3 to 18 carbon atoms.

17. Use of a composition according to claim 1, with a defined amount of moisture or water or with solvents comprising water or with moisture or water or with solvents comprising water to activate the composition.

18. Use of a composition according to claim 1 for the production of coating material, of adhesive, of sealants, of insulation materials and/or of mouldings.

19. Formulation comprising a composition according to claim 1,
characterized in that it comprises
A) at least one compound comprising at least one carbodiimide group and
B) at least one compound comprising at least one anhydride group in a molar ratio of about 2:1, and also auxiliaries and additives.
